(19) United States
(12) Patent Application Publication
(10) Pub. No.: US 2022/0381064 A1
(43) Pub. Date: Dec. 1, 2022

(54) Lock Actuation Assembly

(71) Applicant: Essence SmartCare Ltd., Herzeliya Pituach (IL)

(72) Inventors: Eliav BAR SHIMON, Ganei-Tikva (IL); Sharon BARUCH, Ganei-Tikva (IL); Yuval SOLTZ, RaAnana (IL); Yaron OPPENHEIM, Herzliya (IL)

(21) Appl. No.: 17/787,538

(22) PCT Filed: Dec. 29, 2020
(86) PCT No.: PCT/IL2020/051346

§ 371 Date: Jun. 20, 2022

(30) Foreign Application Priority Data
Dec. 30, 2019 (GB) 1919432.3

(51) Int. Cl. E05B 47/00

(52) U.S. Cl. CPC E05B 47/0012; E05B 2047/0017; E05B 2047/0083; E05B 2047/0091

(57) ABSTRACT

Disclosed is a lock actuation assembly for actuating a lock of a door. Prior to first commanding a motor to rotate a key in the key hole a controller of the lock actuation assembly is configured to: receive an indication that a key holder is disposed to have the key at least partially inserted into the key hole; determine a rotational position of a key holder receptacle relative to a mounting portion of the lock actuation assembly from the indication by a position encoder; and store, in an electronic data storage, the rotational position as an initial insertion/extraction position at which the key is insertable to, and extractable from, the key hole.

### TECHNICAL FIELD

The present invention relates to a lock actuation assembly for actuating a lock of a door and methods of operating and installing a lock actuation assembly.

### BACKGROUND

Currently, most retrofittable smart locks/electronically actuated locks are fitted to existing doors by replacing some or all of an existing lock in a door. However, some systems have been developed in which an electronically controlled actuation assembly is fitted to an inside of a door over an existing lock to actuate the existing lock, without replacing any parts of the existing lock.

One such prior lock actuation system has a mounting portion that mounts to the door and a key holder part that is rotated, by a motor, with respect to the mounting portion to turn a key to lock/unlock the lock in the door. The key may be returned by the motor to the unlock position to enable a person on the outside of the door to push the inside key out of the key hole. In doing so, the key may be inserted into the key hole from an outside of the door so that the lock can also be actuated from the outside.

However, such a system requires the mounting portion of the lock actuation system to be mounted in a specific orientation on the door to align the key in the unlock orientation with the key hole in the unlock orientation. This leads to installation challenges and limitations.

An object of the present invention is to provide a lock actuation assembly that addresses one or more of the limitations of the prior art mentioned above.

### SUMMARY OF THE INVENTION

The terms “position” and “orientation” are used herein to describe certain configurations. The term “position” may be associated with an “orientation” and also a “state” of the lock actuation assembly e.g. “locked” or “unlocked”. The term “orientation” may be associated with an angle irrespective of the “state” of the lock actuation assembly. For instance, an “unlocked position” and a “locked position” may have the same “orientation”. As an example, the “locked position” may be vertical whilst the lock actuation assembly is in a locked state, and the “unlocked position” may also be vertical whilst the lock actuation assembly is in an unlocked state.

A first aspect of the present invention provides a lock actuation assembly for actuating a lock of a door comprising: a mounting portion configured to be mounted to a door for fixing a position of the lock actuation assembly relative to a door lock; a key holder for holding a key for insertion into a key hole of the door lock; a key holder receptacle rotatably coupled to the mounting portion for rotating the key in the key hole when the lock actuation assembly is fixed in position relative to the door lock; a controller; a position encoder configured to indicate to the controller, rotational position of the key holder receptacle relative to the mounting portion; and a motor to rotate the key holder receptacle, wherein prior to first commanding the motor to rotate the key in the key hole the controller is configured to:

receive an indication that the key holder is disposed to have the key at least partially inserted into the key hole;

in response to the indication, determine a rotational position of the key holder receptacle relative to the mounting portion from the indication by the position encoder; and

store, in an electronic data storage, the rotational position as an initial insertion/extraction position at which the key is insertable to, and extractable from, the key hole.

Determining the rotational position of the key holder and storing the rotational position in an electronic data storage enables a position at which the key is insertable to, and extractable from, the key hole to be ascertained through processing rather than being based on a predetermined orientation of the key holder with respect to the mounting portion. Once ascertained, the position may be used by the controller to the control the key's rotational position relative to the initial insertion/extraction position. The lock actuation assembly may therefore be installed in any orientation.

In one or more embodiments, the lock actuation assembly further comprises an orientation sensor configured to indicate orientation with respect to a vertical axis of an environment in which the lock actuator assembly is mounted, wherein the controller is configured to:

configure the motor to rotate the key holder receptacle substantially to an expected insertion/extraction position based on the indication from the orientation sensor prior to:

receiving the indication that the key holder is disposed to have the key at least partially inserted into the key hole.

By positioning the key holder receptacle at the expected insertion/extraction position of the key, any required rotational movement of the key holder receptacle with respect to the key hole prior to inserting the key into the key holder receptacle is reduced. It is noted that the expected insertion/extraction position need not be exactly the same as the insertion/extraction position as defined according to the aspect above, provided that the expected insertion/extraction position is in the vicinity of the insertion/extraction position. Naturally, an installer may provide additional adjustment to the rotational position of the key holder from the expected insertion/extraction position to the actual insertion/extraction position.

In one or more embodiments, the orientation sensor comprises an accelerometer. Thus the orientation is relative to a gravitational force direction.

In one or more embodiments, the orientation sensor is mounted in connection with the key holder so that the indication from the orientation sensor indicates the orientation of the key holder.

In another one or more embodiments the orientation sensor is mounted in connection with the mounting portion of the lock actuation sensor so that the indication from the orientation sensor indicates the orientation of the key holder. In such embodiments there is the position of the key holder with respect to the body is known, for example using any other means described herein. Using such means, the position of the key holder with respect to the mounting portion may be calibrated prior to installation, for example in the factory, and optionally again at installation. Using the knowledge of the position of the key holder with respect to the mounting portion, the orientation of the key holder with respect to a vertical axis may be determined based on the indication from the orientation sensor that is mounted in connection with the mounting portion.

In one or more embodiments, the controller is configured to:

receive a command to configure the lock actuation assembly to adopt a locked state; and

configure the motor to rotate the key holder receptacle to a locked position in response to receiving the command to configure the lock actuation assembly to adopt the locked state.

Configuring the motor to rotate the key holder receptacle to a locked position may comprise the controller using the encoder to determine the locked position. The term “determining a locked position” is used to mean any way in which the controller identifies the position that the key holder needs to be in to be in the locked state. For instance, in some embodiments the controller determines the locked position by reading/receiving at least one parameter related to control of the motor, wherein the at least one parameter encodes the locked position from an internal memory. The at least one parameter may for example be, or be derived from, the stored rotational position corresponding to the insertion/extraction position when the lock is in the locked state, or may be or be derived from another stored value of the encoder that was known to have been received when the lock is in the locked state.

In one or more embodiments, the controller is configured to:

receive a command to configure the lock actuation assembly to adopt an unlocked state; and

configure the motor to rotate the key holder receptacle to an unlocked position in response to receiving the command to configure the lock actuation assembly to adopt the unlocked state.

Configuring the motor to rotate the key holder receptacle to an unlocked position may comprise the controller using the encoder to determine the unlocked position. The term “determining an unlocked position” is used to mean any way in which the controller identifies the position that the key holder needs to be in to be in the unlocked state. For instance, in some embodiments the controller determines the unlocked position by reading/receiving at least one parameter related to control of the motor, wherein the at least one parameter encodes the unlocked position from an internal memory. The at least one parameter may for example be, or be derived from, the stored rotational position corresponding to the insertion/extraction position when the lock is in the unlocked state, or may be or be derived from another stored value of the encoder that was known to have been received when the lock is in the unlocked state.

In one or more embodiments, the controller is configured to: configure the motor to rotate the key holder receptacle to a rest position in said adopted state. The term “rest position” may be used to denote an orientation of the key holder in a locked state or an unlocked state dependent on whether the key holder has been rotated to the rest position from the locked position or the unlocked position.

In one or more embodiments, the rest position is an insertion/extraction position for the locked state, wherein the insertion/extraction position for the locked state has a same orientation as the initial insertion/extraction position. The term “insertion/extraction position for the locked state” may be used to denote an orientation of the key holder at which the key may be inserted into or extracted from the key hole when the lock actuation assembly is in a locked state. In this way, a key may be inserted from an outside by pushing the key in the key holder out from the inside, so that the door lock is unlockable manually.

In one or more embodiments, the rest position is an anti-tamper position for the locked state, wherein the anti-tamper position for the locked state has a different orientation to the initial insertion/extraction position to prevent extraction of the key from the key hole. The term “anti-tamper position for the locked state” may be used to denote an orientation of the key holder that prevents the key from being inserted into or extracted from the key hole when the lock actuation assembly is in a locked state. In this way, any unexpected attempts to unlock the door lock can be prevented by preventing insertion of another key from an outside by blocking the key hole.

In one or more embodiments, the rest position is an insertion/extraction position for the unlocked state, wherein the insertion/extraction position for the unlocked state has a same orientation as the initial insertion/extraction position. The term “insertion/extraction position for the unlocked state” may be used to denote an orientation of the key holder at which the key may be inserted into or extracted from the key hole when the lock actuation assembly is in an unlocked state. In this way, another key may be inserted to the key hole from the outside to lock the door manually by pushing the existing key out of the key hole from the interior side.

In one or more embodiments, the rest position is an anti-tamper position for the unlocked state, wherein the anti-tamper position for the unlocked state has a different orientation to the initial insertion/extraction position to prevent extraction of the key from the key hole. The term “anti-tamper position for the unlocked state” may be used to denote an orientation of the key holder that prevents the key from being inserted into or extracted from the key hole when the lock actuation assembly is in a locked state. In this way, any unexpected attempts to lock the door lock can be prevented by preventing insertion of another key from an outside by blocking the key hole.

In one or more embodiments, the encoder is a rotary encoder.

In one or more embodiments, the rotary encoder is a magnetic encoder.

In one or more embodiments, the controller is configured to: configure the motor to rotate the key holder receptacle using closed loop control based on the rotational position of the key holder receptacle measured by the encoder.

In one or more embodiments, the motor is a brushed DC motor. A brushed DC motor using closed loop control is advantageously cheaper than using, for example, a stepper motor, which is an open loop-controlled motor.

In one or more embodiments, the key holder is biased towards a lock-facing side of the lock actuation assembly. In this way, the key in the key holder may be pushed back into the key hole even if it is pushed out from the exterior side of the door lock, for example, by another key being inserted from the outside.

In one or more embodiments, upon removing a cover portion of the housing, the key holder is accessible from a top side of the lock actuation assembly for manually rotating the key holder with respect to the lock actuation assembly. In this way, the lock can still be actuated, via rotation of the key holder receptacle, in the event of a malfunction of the lock actuation assembly.

In one or more embodiments, the initial insertion/extraction position is one of an insertion/extraction position in a locked state and an insertion extraction position in an unlocked state and the controller is further configured to calculate the insertion/extraction for the other of the locked or unlocked state using the indication from the encoder in response to said indication. The calculating of the insertion/extraction for the other of the locked or unlocked state may also use prior knowledge of an amount that the encoder value changes per turn of the lock.

According to a second aspect of the present invention, there is provided a lock actuation assembly comprising: a mounting portion configured to be mounted to a door for fixing a position of the lock actuation assembly relative to a door lock; a key holder for holding a key for insertion into a key hole of the door lock; a key holder receptacle rotatably coupled to the mounting portion for rotating the key in the key hole when the lock actuation assembly is fixed in position relative to the door lock; an orientation sensor configured to indicate orientation with respect to a vertical axis of an environment in which the lock actuation assembly is mounted; a motor configured to rotate the key holder receptacle relative to the mounting member; and a controller configured to:

configure the motor to rotate the key holder receptacle substantially to an expected insertion/extraction position based on the indication from the orientation sensor.

According to a further aspect of the present invention, there is provided a method of operating a lock actuation assembly according to the first aspect of the invention, the method comprising:

receiving an indication that the key is at least partially inserted into the key hole;

determining, in response to the indication, the rotational position of the key holder receptacle relative to the mounting portion from the indication from the position encoder; and

storing, in an electronic data storage, the rotational position as an initial insertion/extraction position at which the key is insertable to, and extractable from, the key hole.

According to a further aspect of the present invention, there is provided a method of operating a lock actuation assembly according to the second aspect of the invention, the method comprising:
configuring the motor to rotate the key holder receptacle substantially to an expected insertion/extraction position based on the indication from by the orientation sensor.

According to a further aspect of the present invention, there is provided a non-transitory computer-readable medium including instructions stored thereon that, when executed by a processor of a controller, cause the processor of the controller to perform either of the methods above.

According to a further aspect of the present invention, there is provided a method of installing a lock actuation assembly according to any of the first or second aspects of the invention, the method comprising:

placing the key holder receptacle in an installation position wherein the key holder receptacle is substantially concentric with the key hole; and

mounting the mounting portion, with the key holder receptacle in the installation position, to a door in which the lock actuation assembly is to be mounted.

Each embodiment of the first and second aspect of the invention is also applicable to the other aspects of the invention.

As used herein, except where the context requires otherwise, the terms “comprises”, “includes”, “has”, and grammatical variants of these terms, are not intended to be exhaustive. They are intended to allow for the possibility of further additives, components, integers or steps.

As used herein the term “signals” in the plural is not intended to imply that there must be more than one signal in space. The different signals may occupy the same space but at different times. For example, the different signals may come from a single output, wherein the different signals represent different data from the same output, for example by indicating different values of the same parameter.

Various embodiments of the invention are set out in the claims at the end of this specification. Further aspects of the present invention and further embodiments of the aspects described in the preceding paragraphs will become apparent from the following figures and description, given by way of non-limiting example only. As will be appreciated, other embodiments are also possible and are within the scope of the claims.

### BRIEF DESCRIPTION OF THE DRAWINGS

The present invention is best described with reference to the accompanying figures, in which:

FIG. 1 shows a front view of a door including a door lock;

FIG. 2 shows the door lock from FIG. 1 with a lock actuation assembly, according to one or more embodiments of the present invention, installed thereon;

FIGS. 3A-3C show various views of the lock actuation assembly from FIG. 2, where FIG. 3A is a perspective view, FIG. 3B is a top view, and FIG. 3C is a side view, with FIG. 3C also depicting a key in key holder, which can be driven by a motor in the lock actuator assembly;

FIG. 4 shows a perspective view of a removable top portion of a housing of the lock actuation assembly from FIGS. 3A-3C;

FIGS. 5A-5C show various views of a key in key holder that is an accordance with the depicted key and key holder from FIG. 3C, the key holder holding a key, where FIG. 5A is a perspective view, FIG. 5B is a bottom view, and FIG. 5C is a top view;

FIGS. 6A and 6B show similar views to FIG. 3B of the lock actuation assembly from FIG. 2, but with the top portion of FIG. 4 absent, where FIG. 6A shows the lock actuation assembly without the key holder from FIG. 4 installed in a key holder receptacle, and FIG. 6B shows the lock actuation assembly with the key holder from FIG. 4 installed in the key holder receptacle;

FIG. 7 shows a block diagram of the lock actuation assembly from FIG. 2 including a controller, a motor, and sensors, and a user interface in communication with the controller;

FIG. 8 shows a block diagram of the controller from the lock actuation assembly from FIG. 7;

FIG. 9 shows a front view of the mobile device from FIG. 7;

FIG. 10 shows a side view of one of the sensors from FIG. 7 in the form of a magnetic encoder;

FIGS. 11A-E shows bottom views of the lock actuation assembly at various orientations;

FIG. 12 is a flow diagram of a method of installing the lock actuation assembly from FIG. 2; and

FIG. 13 is a flow diagram of a method of operating the lock actuation assembly from FIG. 2.

### DETAILED DESCRIPTION

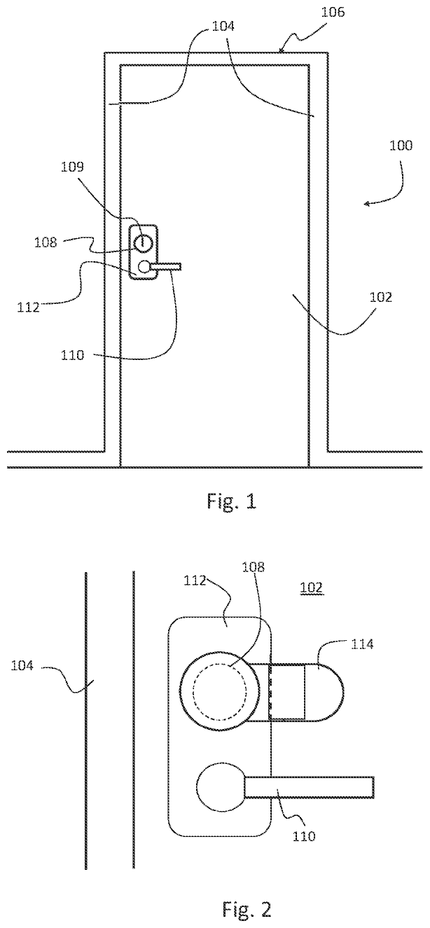

With reference to FIG. 1, a door 100 includes a panel 102, which is mounted to a vertical post 104 of a door frame 106 by vertical hinges (not shown). A lock 108 (or lock assembly) is integrated into the door 100. The lock 108 comprises a cylinder (not shown), which may be a double cylinder for insertion of a key from either side of the door, but in other cases it may be a single cylinder. Rotation of a key actuates a lock-mechanism (e.g. a pin tumbler mechanism or any other lock-mechanism) in the cylinder to move selectively a bolt (not shown). The bolt is insertable into a recess in the doorframe 106. In particular, the recess is included in a vertical post 104 opposite the vertical post 104 that supports the panel 102. The bolt is movable into an extended position in the recess or a retracted position outside the recess to allow the door 100 to move freely between open and closed positions.

The lock 108 also includes a keyhole 109. A key is inserted into the keyhole 109 in order to configure the lock 108 to be in a locked state or an unlocked state by selectively positioning the bolt in the recess.

A door handle 110 is installed on the door 100. The door handle 110 may be a rotating cantilever or knob or a fixed handlebar that protrudes from the door 100. The handle 110 protrudes from the door 100 from a position on the door that is vertically below the lock 108. The door handle 110 may be coupled to a latch (not shown). The latch may be insertable into a further recess (not shown) in the post 104 to prevent the door from opening when in a closed position.

The lock 108 may also include an escutcheon 112 mounted to the panel 102.

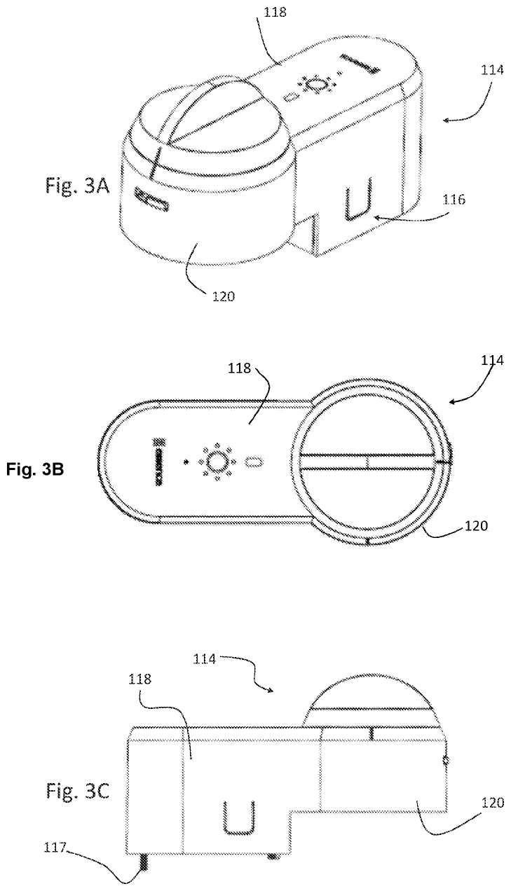

As shown in FIG. 2, the lock 108 is fitted with a lock actuation assembly 114, according to an embodiment of the present invention. The lock actuation assembly 114 is provided for actuating the door lock 108. With reference to FIGS. 3A-C, the lock actuation assembly 114 includes a housing 116 including a mounting portion 118 and a head 120. The housing 116 is substantially hollow to include the other components of the lock actuation assembly 114 described below. The mounting portion 118 includes a flat contact surface 119 arranged to rest flush on the door panel 102. The lock actuation assembly 114 may include a fixing element 117 for fixing the lock actuation assembly 114 to the door 100. The fixing element 117 is in the form of a screw. In addition to or instead of the screw, the contact surface may comprise an adhesive to stick the mounting portion 118 to the door. In this way, the mounting portion 118 is configured to be mounted to the door for fixing a position of the lock actuation assembly relative to the door lock.

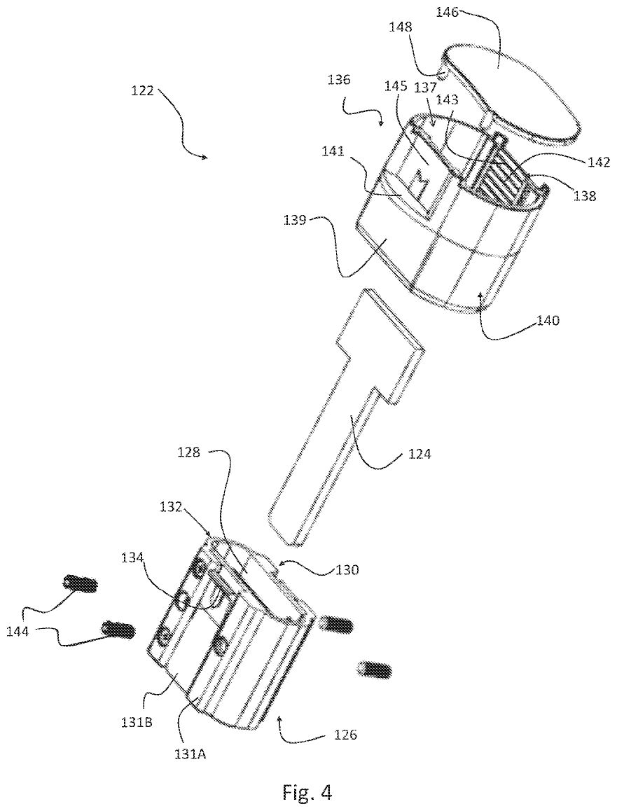

The head 120 includes a surface parallel with said surface of the mounting portion 118 and spaced to accommodate the escutcheon 112 when the lock actuation assembly 114 is installed. The head 120 also has a key holder receptacle (not shown in FIG. 3C) that holds a key holder 122. The key holder receptacle can rotate within the head when driven to do so by a motor in the key actuator assembly, and couples its rotation to the key holder 122. The key holder 122 can move along the axis of the rotation of the couple to enable the key to be inserted and removed from the key hole of the lock. However, the key holder is biased towards the key hole by one or more springs 123, which may be positioned to push the key holder 122 away from an inside surface or a removable top cover 127 of the housing 116. The top cover 127 is shown removed from the rest of the lock actuation assembly, in FIG. 4.

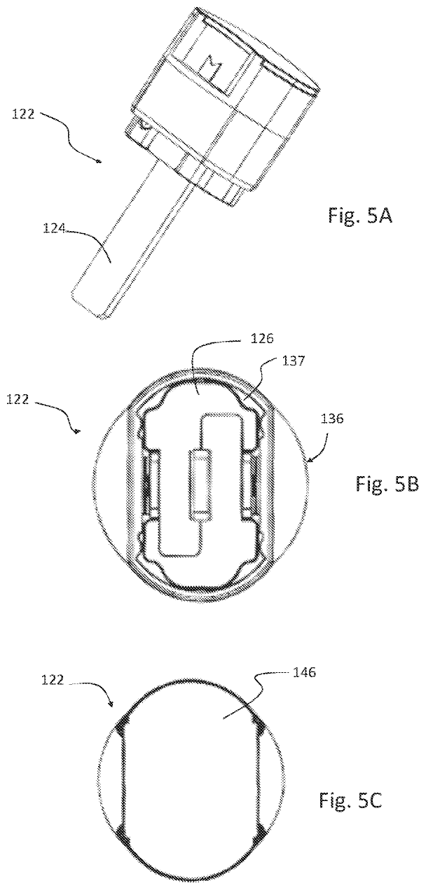

With reference to FIG. 5A, the key holder 122 is arranged to hold a key 124 for insertion into the keyhole 109 (see FIG. 1). The key holder 122 clamps a head (not shown) of the key 124 with a key shaft 125 protruding through and expending from a slot in a bottom 128 of the key holder 122. The clamping is performed by a clamp 126, which is held without a shroud 136.

The key holder 122 has a lid 146 that is removably attachable to a top end 148 of the shroud 136 to insert or remove the key 134 from the key holder 122 via a top end 148 of the shroud 136.

FIG. 5B shows a bottom view of the key holder 122. The clamp 126 is within a hole 137 of the shroud 136.

FIG. 5C shows a top view of the key holder 122.

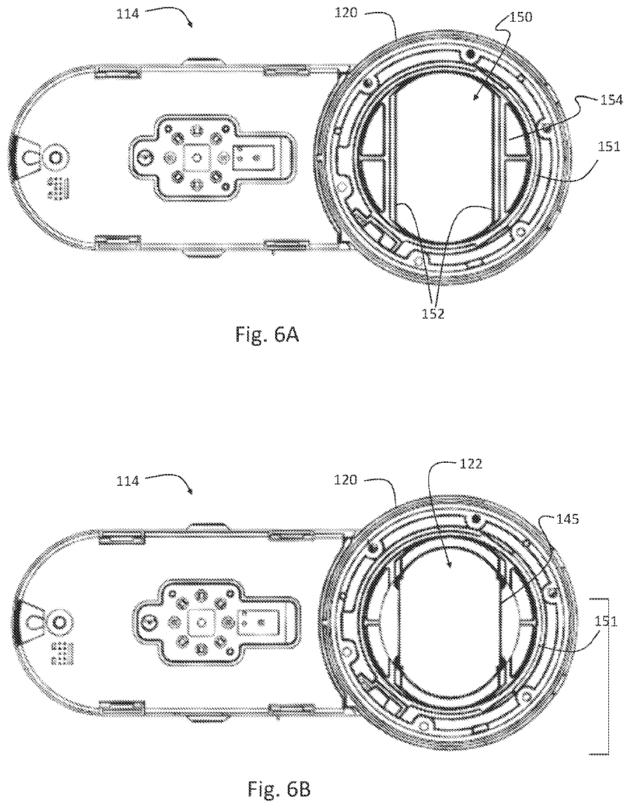

FIG. 6 shows a top view of the lock actuation assembly 114 with top cover 127 removed. In FIG. 6A, the lock actuation assembly 114 shows a key holder receptacle 150 with the key holder 122 absent.

FIG. 6B shows the same view as FIG. 6A but with the key holder 122 slotted into the receptacle 150. A top part 145 of the key holder 122 may be accessed when the cover 127 is removed to insert or remove the key holder and/or to manually rotate the key holder in an event of an electrical or motor failure within the key actuation assembly 114.

With reference to FIG. 7, the lock actuation assembly 114 includes a controller 160, a power source 162, a communication module 164, a motor 168, a position encoder 170, a relative positional indicator 172, and an orientation sensor 174.

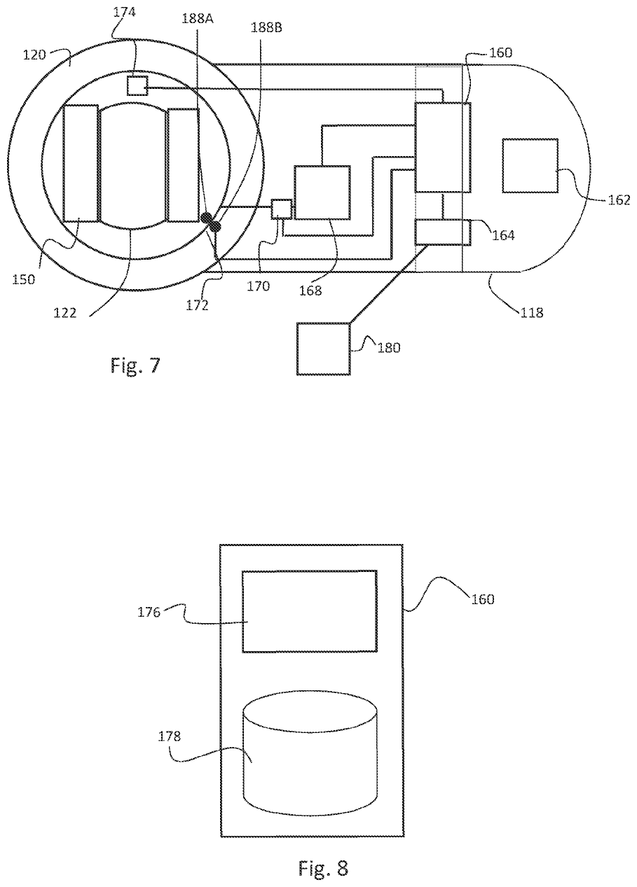

With reference to FIG. 8, the controller 160 includes a processor 176. The processor 176 may comprise any one or more processing devices, e.g. a microcontroller, microprocessor, field programmable gate array (FPGA), application-specific integrated circuit (ASIC) chip. The controller 160 also includes a memory 178, which may be integrated with the processor 176 in the controller and/or may be in one or more chips that are separate from processor 176. Further the memory 178 may comprise a plurality of memory types and/or devices as would be known by a person skilled in the art. For example, non-transient memory may store code for configuring the functions and methods performed by processor(s) and transient memory may be used by the processor(s) to write and read temporary data used by the processor(s) during their operation.

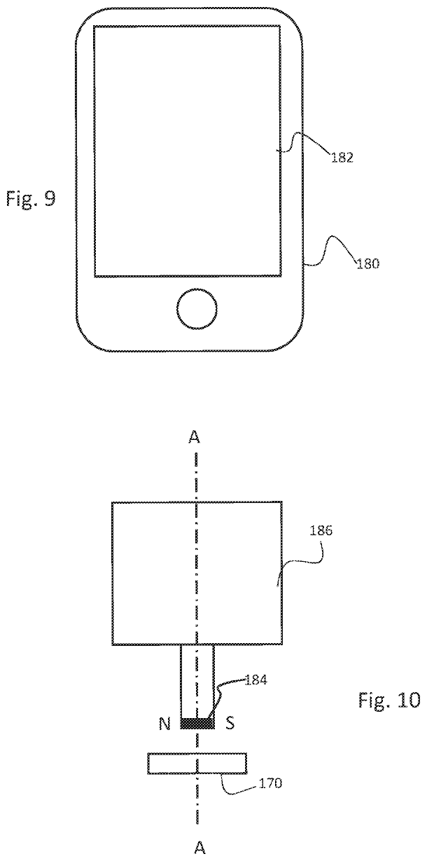

During use, an electronically derived command may be received by a user interface 180 (FIG. 7). The user interface 180 communicates with the controller 160 via the communication module 164, or the communication module may be integrated into the controller 160, for example by having its functions executed by processor 176. The communication module may include a receiver, a receiver and transmitter, or may be a transceiver. The user interface 180 may be provided as an electronic input on the housing 116. Alternatively, the user interface may be on a remote electronic device such as shown in FIG. 9. With reference to FIG. 9, the electronic device is shown as a smart phone but may be a tablet or other computing device. The electronic device may provide the user interface by including a touchscreen 182 to receive user input and also provide information about the lock actuation assembly 114 to the user.

With reference to FIG. 7, the power source 162 is a battery. The power source 162 provides power to each of the components of the lock actuation assembly 114.

The controller 160 is communicatively coupled to the motor 168. The motor 168 is powered by the power source 162. The motor 168 is configured to rotate the key holder receptacle 150 relative to the mounting portion 118. The motor 168 in this embodiment is a brushed DC motor. The motor 168 is arranged to rotate the key holder receptacle 150 using closed loop control by using the encoder 170 to sense a rotational position of the key holder receptacle 150 relative to the mounting portion 118. The motor 168 has an output shaft with a gear meshed with a gear attached to the key holder receptacle 150. The gear attached to the key holder receptacle 150 is concentric with the axis of rotation of the key holder 122.

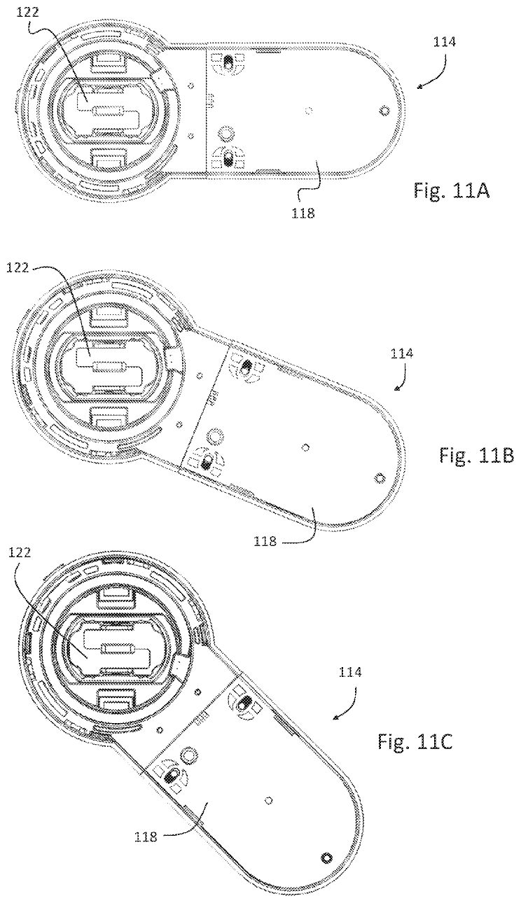

The position encoder 170 is configured to generate, and transmit to the controller 160, one or more signal associated with rotational positions of the key holder receptacle 150 relative to the mounting portion 118. The position encoder 170 may be a rotary encoder. The rotary encoder may be a magnetic encoder. With reference to FIG. 10, a magnet 184 is connected to a gear 186 of the motor 168. The magnet 184 is concentric with a central axis A of the gear 186. The magnetic north, N, and magnetic south, S, poles are included in FIG. 10 for illustrative purposes. The magnetic position encoder 170 is spaced from the magnet 184 and concentrically aligned with the axis A. In this way, the magnetic position encoder 170 senses the orientation of a magnetic field and indicates sensed orientation of the magnetic field. The indication of the sensed orientation may be provided by one or more signals. The orientation of the magnetic field is associated with the rotational position of the key holder receptacle 150 and thus the key holder 122 since the gear 186 is connected to the key holder receptacle 150. Accordingly, an orientation of the gear 186 can be used to interpret the rotational position of the key holder receptacle 150. In this sense, the terms “rotational position” and “orientation” of the key holder receptacle may be used interchangeably. As will be appreciated by the person skilled in the art, an encoder (magnetic or otherwise) may alternatively be configured in other ways to measure the rotational position of the of the key holder receptacle.

With further reference to FIG. 7, the relative positional indicator 172 is configured to indicate to the controller 160 the position of the key holder receptacle 150 relative to the mounting portion 118. As described in more detail below, in operation, the relative positional indicator 172 is configured to indicate to the controller 160 when the key holder receptacle 150 is at a first predetermined position relative to the mounting portion 118 and a second predetermined position relative to the mounting portion 118. To achieve this, the relative positional indicator 172 includes an alignment part 188A on the key holder receptacle 150 and an alignment part 188B on the mounting portion 118. In the illustrated embodiment, there is a single alignment part on the key holder receptacle 150 and a single alignment part 188B on the mounting portion 118. In other embodiments, there may be more than one alignment parts 188A on the key holder receptacle 150 and/or more than one alignment parts 188B on the mounting portion 118. In such a case, the alignment parts are positioned to be aligned at the first predetermined position or the second predetermined position. In other words, when there is more than one alignment parts on either the key holder receptacle 150 and/or on the mounting portion 118, the first and second predetermined positions may have different orientations, e.g. 90 degrees, or 180 degrees, separation. In this way, the first and second predetermined positions may be separated by a predetermined angle of separation. In the case where there is only a single alignment part 188A on the key holder receptacle 150 and a single alignment part 188B on the mounting portion, the first and second predetermined positions have the same orientation and the predetermined angle of separation is 360 degrees.

The alignment parts for part of a switch or other circuit, wherein one or more signals are generated when the alignment parts are aligned. For example, the alignment parts may include electrical contacts such that the alignment parts form a switch that when aligned, contact each other to close an electrical circuit and when not aligned the electrical circuit is open. In this way, the positional indicator 172 is arranged to indicate to the controller 160 that the key holder receptacle 150 is at the first/second predetermined position when one of the one or more alignment parts on the mounting portion 118 is aligned with one or the one or more alignment parts on the key holder receptacle 150.

Knowledge of the predetermined angle of separation may be used by the controller 160 to calibrate the encoder 170, as will be appreciated by a person skilled in the art. Such calibration may be repeated during every transition between locked and unlocked states.

The orientation sensor 174 is configured to indicate orientation with respect to a vertical axis of an environment in which the lock actuator assembly 114 is mounted. The orientation may be indicated using one or more signals. The orientation sensor 174 may achieve this by comprising an accelerometer coupled to the key holder receptacle 150. The accelerometer may be a multi-axis accelerometer, for example a 3-axis accelerometer. The accelerometer is able to generate one or more signals indicative of the orientation of the key holder receptacle 150 relative to a gravitational force direction.

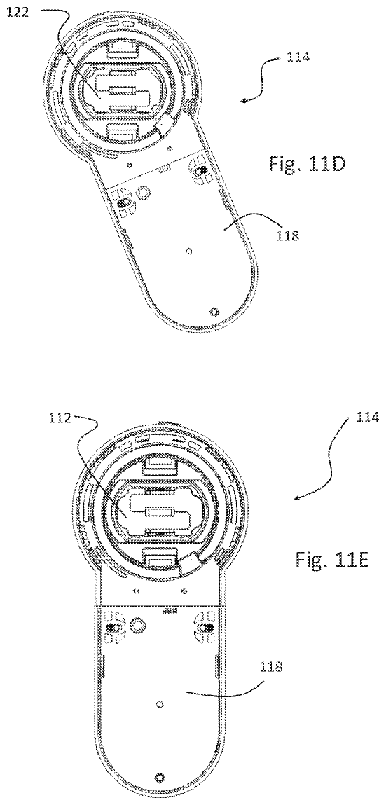

FIGS. 11A-E show a bottom view of the lock actuation assembly 114 with the mounting portion 118 at various orientations. For instance, FIG. 11A shows the mounting portion 118 at a horizontal orientation. FIG. 11E shows the mounting portion at a vertical orientation. FIGS. 11B-D show the mounting portion 118 in different orientations in between horizontal and vertical. In all cases, it can be seen that the key holder 122 is in the same orientation, namely horizontal. This is because an insertion/extraction position of the key, i.e. where the key is insertable to and extractable from the key hole, is in a horizontal orientation in this embodiment.

The modes of operation of the lock actuation assembly 114 will now be described.

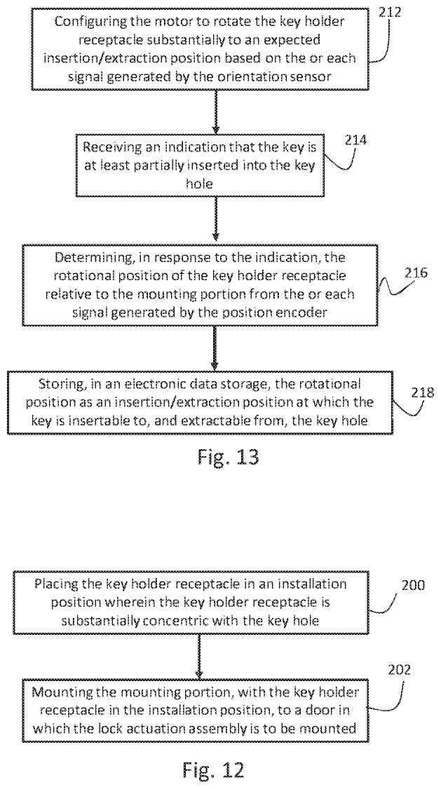

With reference to FIG. 12, a method of installing the lock actuation assembly 114 from FIG. 2 will be described. The method includes, at step 200, moving the key holder receptacle 150 to an installation position wherein the key holder receptacle 150 is concentric with the key hole 109. In this way, the key holder 122 can be inserted into the key holder receptacle 150 since the key can be inserted into the key hole 109. At this position, at step 202, the mounting portion 118 is mounted to the door 100. Once the key holder has been inserted into the key holder receptacle, the top portion 127 of the housing 116 is clicked into place, to cover the key holder 122.

Once the lock actuation assembly 114 has been mounted to the door, the controller is configured to rotate the key holder receptacle 150 substantially to an expected insertion/extraction position. The controller 160 may determine the expected insertion/extraction position by receiving parameter that defines whether the keyhole is a vertical or horizontal slit when there the key is insertable to key hole. The parameter may for example be obtained by a user input, e.g. via the mobile device 180. Alternatively, the controller 160 may obtain the parameter from electronic data stored in the memory 178, or from one or more signals associated with a switch or button on the device. The determination of the expected insertion/extraction position then involves estimating a position that the key holder needs to be in order for the key in the key holder to be aligned with orientation of the key hole. The estimation is based on a sensed orientation with respect to the vertical axis from which it is determined roughly how the key is orientated with respect to the vertical axis. The expected insertion/extraction position is a position of the key holder receptacle 150 that is considered to be approximately in the vicinity of the actual insertion/extraction position. In the exemplified embodiment shown in FIG. 11, the expected insertion/extraction position is horizontal, i.e. perpendicular to the gravitational force direction. In other embodiments, the expected insertion/extraction position may be vertical. In any case, the motor 168 is configured to rotate the key holder receptacle 150 to the expected insertion/extraction position based on one or more signals generated by the orientation sensor 174, the one or more signal being associated with the orientation of the key holder receptacle 150.

With reference to FIG. 13, when the key holder receptacle 150 is at the expected insertion/extraction position, at step 210 the controller 160 determines an expected insertion/extraction position of the key holder 122.

Next, at step 212, the controller 160 is arranged to configure the motor 168 to rotate the key holder receptacle 150 substantially to the expected insertion/extraction position based on the one or more signals generated by the orientation sensor 174. As described above, the insertion/extraction position includes an orientation at which the key is insertable to and extractable from the key hole 109. The expected insertion/extraction position need not be aligned completely with an actual insertion/extraction position, since the aim of moving the key holder receptacle 150 to the expected position is so that little or no manual movement of the key holder receptacle is required for alignment of the key and keyhole to thereby relieve burden from the operator. The expected insertion/extraction position may be substantially vertical or may be substantially horizontal, in normal lock installations.

When the user inserts a key into the key holder 122 when it is in the key holder receptacle 150, i.e. such that the key is at least partially, inserted into the keyhole 109, an indication is sent to the controller 160 at step 214. The indication may come from a user input, whereby an installer uses the user input to tell the controller 160 that the key is at least partially inserted into the keyhole 109. Alternatively, the indication may come from a sensor (not shown) mounted to the key holder receptacle 150 that detects when the key holder, or a part thereof, is sufficiently within the key holder receptacle to imply that the key is at least partially inserted into, and therefore aligned with, the keyhole. In some embodiments, the indication may more specifically indicate partial insertion, and in other embodiments the indication may more specifically indicate full insertion, into the keyhole. In embodiments in which the key is or may be in fully inserted prior to indication being received, the lock actuation assembly 114 does not rotate the key, and/or may prevent rotation of the key, in the key hole prior to the receipt of the indication. This ensures that insertion position is not lost prior to the receipt of the indication. Thus, the receipt of the indication, and the determining of the rotational position of the key holder receptacle relative to the mounting portion from the one or more signals generated by the position encoder in response to the indication, occurs prior to the first time the controller commands the motor to rotate the key in the key hole.

Next, at step 216, the controller 160 is configured to determine, in response to the indication, the rotational position of the key holder receptacle 150 relative to the mounting portion 118 from one or more signals generated by the position encoder 170. Though in the above examples the indication is provided when the key is only partially inserted in the ley hole, in other embodiments the indication can be provided when the key is fully in the key hole, as long as the insertion of the key fully into the key hole is performed without rotational force, so that they key does not rotate before the rotational position of the key holder is determined.

Next, at step 218, the controller 160 is configured to store, in the memory or other electronic data storage, the rotational position as an insertion/extraction position at which the key is insertable into, and extractable from, the key hole 109. As described below, this insertion/extraction position can be read from the memory in future by the controller 160 to determine the insertion/extraction position for a locked state, when the lock actuation assembly 114 is locked, and to determine the insertion/extraction position for an unlocked state, when the lock actuation assembly 114 is unlocked. This is because the insertion/extraction position for the locked and unlocked states will have the same orientation but separated by a predefined number of one or more turns of the key. Based on the value of the encoder at the insertion/extraction position that was recorded when the key was at least partially inserted in the key hole, whether that insertion/extraction position be corresponding to the locked or unlocked state, the controller may calculate the insertion/extraction for the other of the locked or unlocked state. This may be achieved for example based on knowing the number of turns between locked and unlocked states, the directions of rotation to switch between the locked and unlocked states, and amount that the encoder value changes per turn of the lock. In some embodiments the amount that the encoder value changes per turn of the lock may be determined by a calibration procedure that is performed prior to installing the lock actuation assembly on the door.

During installation the device can be told (e.g. via one or more wireless signals from a smartphone or an input on the lock actuation assembly) whether the insertion/extraction position that was recorded when the key was at least partially inserted in the key hole corresponding to the locked state or corresponded to the locked state, and/or can be told the direction of travel needed to switch between the states and/or the number of turns needed to switch between the states. Alternatively, some or all of this information can be pre-configured in internal memory, with the installer using a lock actuation assembly that is specific to the number and/or direction of turns needed to switch states and with the installer setting up the lock to be initially in a specific one of the locked or unlocked states that is expected by the controller to be the initial state.

In operation, the door lock 108 can be locked or unlocked. This can be achieved in various ways, using manual instruction from the mobile device 180 using an application, or app, for example. In order to do so, the controller 160 needs to receive a command to switch the key holder receptacle 150 to the locked or unlocked position. Such a command may be received by the controller 160 from a wireless input by the user into the mobile device 180, which is a smart phone in some embodiments. In some cases, the user can install an app on the mobile device 180. The app is then linked with a specific door lock, and receives status information for the door look, either directly or via a network. From the status information the app can know whether the lock is in the locked or unlocked position.

When a command to configure the lock actuation assembly 114 to adopt a locked state is received, the controller 160 configures the motor 168 to rotate the key holder receptacle 150 to the locked position, based on data recorded at installation in the internal memory of the lock actuation assembly that defines where the locked position is, for example corresponding to a particular value for the encoder. Similarly, when a command to configure the lock actuation assembly 114 to adopt an unlocked state is received, the controller 160 configures the motor 168 to rotate the key holder receptacle 150 to the unlocked position, based on data recorded at installation in the internal memory of the lock actuation assembly that defines where the unlocked position is, for example corresponding to a particular value for the encoder.

After the lock is configured to adopt a locked or unlocked state, the controller 160 may subsequently configure the motor 168 to rotate the key holder receptacle 150 to a rest position. The rest position may take various forms.

One form of rest position may be where the user wishes to be able to insert manually a key from an outside into the key hole 109. To facilitate this, the rest position is either in a first insertion/extraction position in which the lock is in the locked state or a second insertion/extraction position in which the lock is in the unlocked state. The insertion/extraction position for the locked and unlocked states has the same orientation as the initial insertion/extraction position initially identified by the controller 160. In this way, another key may be inserted to the key hole 109 which pushes the key 124 out at the inside of the door lock. When the manual lock or unlock operation has been performed, the key can be withdrawn from the outside of the door lock and the key 124 returned back into the key hole 109 as a result of being biased towards a lock-facing side of the lock actuation assembly 114. In some embodiments, the insertion/extraction positions for the locked and unlocked states are the same as the locked and unlocked positions, respectively. For such embodiments, no further additional action is required to reach this rest position one the commanded locked or unlocked state position is reached.

Another form of the rest position may be an anti-tamper position for the locked or unlocked states. In this way, a further key is prevented from being inserted into the key hole 109 when the lock actuation assembly 114 is at a rest position. To achieve this, the anti-tamper positions for the locked and unlocked states have a different orientation to the initial insertion/extraction position to prevent pushing of the key 124 from the key hole 109 by an attempted insertion of a further key from the outside. Since, in the anti-tamper position, the key 124 cannot be pushed from the keyhole, the further key cannot be inserted. In some embodiments, the anti-tamper positions for the locked and unlocked states (as opposed to the insertion extraction positions, for example) are the same as the locked and unlocked positions, respectively. For such embodiments, no further additional action is required to reach this rest position one the commanded locked or unlocked state position is reached.

The foregoing embodiments demonstrate that by storing the initial insertion/extraction position, the lock actuation assembly may be installed at any orientation on the door, yet the controller 160 may perform one or more additional operations that are dependent on the orientation of the key with respect to the key hole.

In other embodiments (not shown), the key holder may take other forms. For example, an alternative key holder may simply be a clamp that clamps upon the head of the key after the key is placed partially into the lock, at and the insertion/removal position is then recorded. Thereafter the key holder may be pushed toward the door to push the key fully into the lock.

Where a given item is referenced herein with the preposition “a” or “an”, it is not intended to exclude the possibility of additional instances of such an item, unless context requires otherwise.

The invention disclosed and defined herein extends to all plausible combinations of two or more of the individual features mentioned or evident from the text or drawings. All of these different combinations constitute various alternative aspects of the invention.

1. A lock actuation assembly for actuating a lock of a door comprising: a mounting portion configured to be mounted to a door for fixing a position of the lock actuation assembly relative to a door lock; a key holder for holding a key for insertion into a key hole of the door lock; a key holder receptacle rotatably coupled to the mounting portion for rotating the key in the key hole when the lock actuation assembly is fixed in position relative to the door lock; a controller; a position encoder configured to indicate to the controller, rotational position of the key holder receptacle relative to the mounting portion; and a motor to rotate the key holder receptacle, wherein prior to first commanding the motor to rotate the key in the key hole the controller is configured to:
receive an indication that the key holder is disposed to have the key at least partially inserted into the key hole;
determine a rotational position of the key holder receptacle relative to the mounting portion from the indication by the position encoder; and
store, in an electronic data storage, the rotational position as an initial insertion/extraction position at which the key is insertable to, and extractable from, the key hole.

2. The lock actuation assembly of claim 1 further comprising an orientation sensor configured to indicate orientation of the key holder receptacle with respect to a vertical axis of an environment in which the lock actuator assembly is mounted, wherein the controller is configured to:
configure the motor to rotate the key holder receptacle to an expected insertion/extraction position based on the indication by the orientation sensor prior to:
receiving the indication that the key holder is disposed to have the key at least partially inserted into the key hole.

3. The lock actuation assembly of claim 2, wherein the orientation sensor comprises an accelerometer.

4. The lock actuation assembly of claim 1, wherein the controller is configured to:
receive a command to configure the lock actuation assembly to adopt a locked state; and
configure the motor to rotate the key holder receptacle to a locked position in response to receiving the command to configure the lock actuation assembly to adopt the locked state.

5. The lock actuation assembly of claim 1, wherein the controller is configured to:
receive a command to configure the lock actuation assembly to adopt an unlocked state; and
configure the motor to rotate the key holder receptacle to an unlocked position in response to receiving the command to configure the lock actuation assembly to adopt the unlocked state.

6. The lock actuation assembly of claim 4, wherein the controller is configured to:
configure the motor to rotate the key holder receptacle to a rest position in said adopted state.

7. The lock actuation assembly of claim 6, wherein the rest position is an insertion/extraction position for the locked state, wherein the insertion/extraction position for the locked state has a same orientation as the initial insertion/extraction position.

8. The lock actuation assembly of claim 6, wherein the rest position is an anti-tamper position for the locked state, wherein the anti-tamper position for the locked state has a different orientation to the initial insertion/extraction position to prevent extraction of the key from the key hole.

9. The lock actuation assembly of claim 5, wherein the controller is configured to: configure the motor to rotate the key holder receptacle to a rest position in said adopted state, wherein the rest position is an insertion/extraction position for the unlocked state, wherein the insertion/extraction position for the unlocked state has a same orientation as the initial insertion/extraction position.

10. The lock actuation assembly of claim 5, wherein the controller is configured to: configure the motor to rotate the key holder receptacle to a rest position in said adopted state, wherein the rest position is an anti-tamper position for the unlocked state, wherein the anti-tamper position for the unlocked state has a different orientation to the initial insertion/extraction position to prevent extraction of the key from the key hole.

11. The lock actuation assembly of claim 1, wherein the encoder is a rotary encoder.

12. The lock actuation assembly of claim 11, wherein the rotary encoder is a magnetic encoder.

13. The lock actuation assembly of claim 4, wherein the controller is configured to:
configure the motor to rotate the key holder receptacle using closed loop control based on the rotational position of the key holder receptacle.

14. The lock actuation assembly of claim 13, wherein the motor is a brushed DC motor.

15. The lock actuation assembly of claim 1, wherein the key holder is biased towards a lock-facing side of the lock actuation assembly.

16. The lock actuation assembly of claim 15, wherein the key holder is accessible from a top side of the lock actuation assembly for manually rotating the key holder with respect to the lock actuation assembly.

17. The lock actuation assembly of claim 1, wherein the initial insertion/extraction position is one of an insertion/extraction position in a locked state and an insertion/extraction position in an unlocked state and the controller is further configured to calculate the insertion/extraction for the other of the locked or unlocked state using the indication from the encoder in response to said indication.

18. The lock actuation assembly of according to claim 17, wherein the calculating of the insertion/extraction for the other of the locked or unlocked state also uses prior knowledge of an amount that the encoder value changes per turn of the lock.

19. A lock actuation assembly comprising: a mounting portion configured to be mounted to a door for fixing a position of the lock actuation assembly relative to a door lock; a key holder for holding a key for insertion into a key hole of the door lock; a key holder receptacle rotatably coupled to the mounting portion for rotating the key in the key hole when the lock actuation assembly is fixed in position relative to the door lock; an orientation sensor configured to indicate orientation with respect to a vertical axis of an environment in which the lock actuation assembly is mounted; a motor configured to rotate the key holder receptacle relative to the mounting member; and a controller configured to:
determine an expected insertion/extraction position of the key holder; and
configure the motor to rotate the key holder receptacle substantially to the expected insertion/extraction position based on the indication from the orientation sensor.

20. A method of operating a lock actuation assembly according to any of claim 1, the method comprising:
receiving an indication that the key is at least partially inserted into the key hole;
determining, in response to the indication, the rotational position of the key holder receptacle relative to the mounting portion from the indication from the position encoder; and
storing, in an electronic data storage, the rotational position as an initial insertion/extraction position at which the key is insertable to, and extractable from, the key hole.

21. (canceled)

22. (canceled)

23. (canceled)
